(19) United States
(12) Patent Application Publication
(10) Pub. No.: US 2024/0249148 A1
(43) Pub. Date: Jul. 25, 2024

(54) METHOD AND SYSTEM FOR DYNAMIC ACCESS CONTROL USING WORKFLOW CONTEXT

(71) Applicant: Motorola Solutions, Inc., Chicago, IL (US)

(72) Inventors: Pawel PAK, Adamow (PL); Jakub SIEDLIK, Tarnow (PL); Szymon SIKORA, Krakow (PL); Maciej STAWISZYNSKI, Krakow (PL)

(73) Assignee: Motorola Solutions, Inc., Chicago, IL (US)

(21) Appl. No.: 18/099,776

(22) Filed: Jan. 20, 2023

(51) Int. Cl. G06N 3/091; G07C 9/32

(52) U.S. Cl. CPC G06N 3/091; G07C 9/32

(57) ABSTRACT

A computer-implemented method comprises monitoring activity associated with a user, determining, by a trained machine learning model using the monitored activity of the user, that the user will need to access an asset that the user does not currently have access to, the machine learning model trained with a plurality of previous workflows completed by previous users and associated access privileges required for the previous workflows; and assigning an access privilege to the user, wherein the user is thereafter able to access to the asset.

### BACKGROUND

An organization may manually manage access by users to certain facilities as part of a security ecosystem. This management typically requires an in-depth knowledge of the facilities and the job requirements of different users. The security ecosystem may further be dynamic, and not static. For example, new users may be added to the security ecosystem, and/or new tasks may be performed by new users and/or existing users of the security ecosystem. Such a dynamic security ecosystem may be part of, for example, a school, a hospital, a police station, or a secure workplace. Access by users to devices and locations within these dynamic security ecosystems may change frequently based on different circumstances. For a user to obtain access to a device or a location, the user often needs to submit a ticket request to a security department or an IT department in the organization and wait for the appropriate person in the department to provide permission to the user to access the desired device or location.

### BRIEF DESCRIPTION OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1A illustrates an exemplary data structure for a workflow, and FIG. 1B illustrates exemplary workflows.

FIG. 2 illustrates an example process for providing dynamic access control using workflow context.

FIG. 3 illustrates an example ecosystem for implementing dynamic access control.

FIG. 4 is a block diagram of a workflow server of FIG. 3.

FIG. 5 is a block diagram of a workstation of FIG. 3.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

This application describes exemplary methods and systems for dynamic access control using workflow context.

The inventors realized that manually managing a system, such as a dynamic security ecosystem, can be time consuming and extremely difficult. For example, configuring proper access control for new users and/or existing users for different devices and systems can be time consuming and complicated. To do so manually requires a person or a department of personnel to have an in-depth knowledge of all of these various devices and systems and an in-depth knowledge of the various users and their job requirements.

The inventors further realized that fulfilling security procedures related to access control in a facility where the level of access for users is changed quite often can be resource consuming, time consuming, susceptible to failures, and/or frustrating both for those enforcing the policies and for the users of the facility. Moreover, in a dynamic environment where there are often resources shifts (e.g., officer shifts in a police station, or security personnel in a shopping mall), configuration of access control may be very time consuming and require a significant effort on an on-going basis.

The inventors additionally realized that controlling access to various aspects of a facility may involve controlling access to a certain physical location (e.g., a room) or a certain device (e.g. a database or a software application stored on a server) that is related to a current workflow of a particular individual.

The inventors realized that a need exists to efficiently configure proper access control for an organization's assets. The inventors also realized that a need exists to securely and efficiently authorize users to access various facilities of the organization. The inventors further realized that a need exists to ensure users perform certain tasks efficiently within the organization and without having users to unduly wait for authorization to perform their tasks.

In some embodiments, learning the previous and/or current workflows of users may allow for dynamically changing the access privileges and saving time by avoiding assigning elevated access rights manually. The security of the system may also be improved by limiting the time window of elevated access rights based on a workflow's progress. Further, the ability to learn and make decisions based on the context of the user activity in a workflow may improve the overall security of an environment or a facility.

Exemplary methods and systems may use a trained machine learning model to determine that a user will need to access an asset that the user does not currently have access to. The trained machine learning model may use monitored activity of the user to make this determination. The machine learning model may be trained with previous workflows completed by previous users and associated access privileges required for the previous workflows. Once a determination is made by the trained machine learning model, the user may be assigned an access privilege so that the user is thereafter able to access the asset.

Exemplary methods and systems described herein provide a practical application by improving how access control for a user is assigned in a system. In some embodiments, access control for the user may be assigned dynamically using workflow context. Using a trained machine learning model, a current workflow for a user may be identified, and based on this identified workflow, an access privilege for the user may be assigned. Using a trained machine learning model, the monitored activity of a user may be used to determine that the user will need access to an asset that the user does not currently have permission to access, and based on this determination, the user may then be permitted to access the asset. In this way, the exemplary methods and systems may enhance efficiency and improve response times, effectiveness, and overall security of the system.

In exemplary embodiments, the system may learn and determine a current workflow of a user and learn which access privilege is needed for the user based on this current workflow. The system may learn from prior workflows and assign an access privilege to the user based on similarities to prior workflows. To learn from prior workflows, the system may monitor current workflows and access rights requested from users in corresponding workflows to build a correlation between workflows and required access rights. The system may learn what access rights should be granted to particular users based on a particular user's current workflow. The system may track back a certain user's activities to learn one or more workflows and dynamically define new workflows. The system may also grant access only when needed, which can help to improve the overall security of a system.

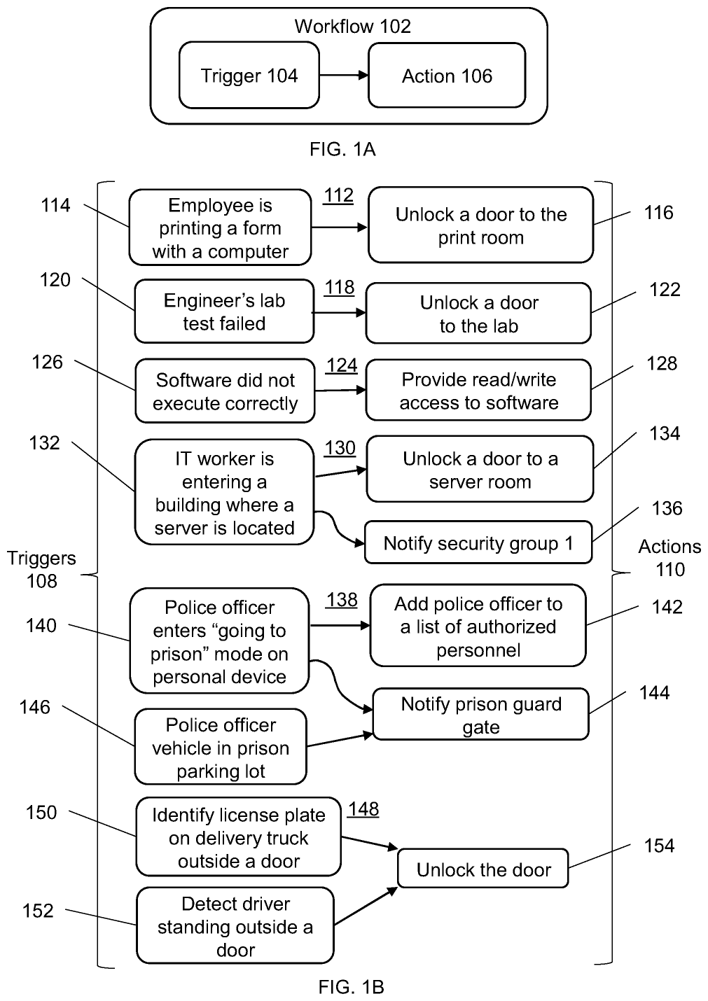

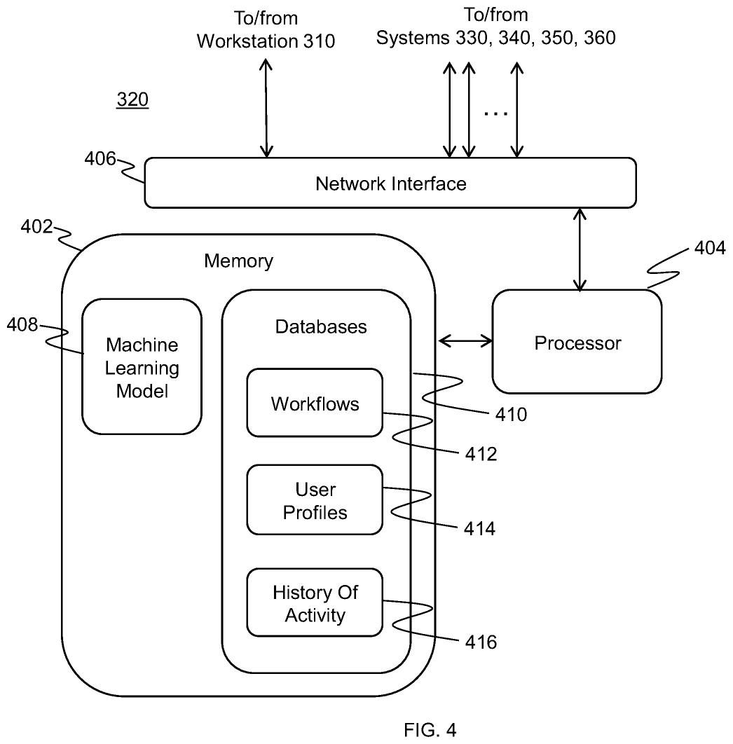

FIG. 1A illustrates an exemplary data structure for a workflow, and FIG. 1B illustrates exemplary workflows. The activities of users in an organization may be organized as workflows. A workflow may represent one or more tasks associated with one or more activities of one or more users. As a data structure, a workflow 102 may include one or more triggers 104 associated with one or more actions 106. The workflows may be stored in a database (e.g., database 412 in FIG. 4). A workflow may have one or more tasks, where each task may have one or more triggers 104 associated with one or more actions 106. In a workflow with a task having one trigger connected to one or more actions, once the trigger occurs, the connected actions follow. In a workflow with a task having multiple triggers connected to one or more actions, once a predetermined combination of the triggers occurs (e.g., all of the triggers, one trigger, or some of the triggers), the connected actions follow.

A workflow may provide a user with access to an asset of the system. Having a workflow assigned to a user may provide an access privilege to an asset that is associated with the workflow. The access to the asset may be temporary, such as being limited to a particular time window. An asset may be, for example, one or more physical assets and/or one or more logical assets. A physical asset may be, for example, a door, a gate, a room, or a building in a geographical location or area (e.g., a warehouse). A logical asset may, for example, an electronic file, a computer-based application, or an electronic resource. A logical asset may be associated with a physical asset located in a geographical location or area.

A trigger 104 may be an event, an activity, and/or a request detected by the system. In some embodiments, a trigger may be initiated by at least one of a device associated with the user or an interaction of the user. For example, a trigger may be at least one of: a detection that a device of the user has entered an area; a detection that a device of the user is in communication with another device; a detection that the user has interacted with a processor-based device (e.g., entered a passcode on a keypad); or a detection of the user interacting with a facial recognition system. A trigger may detect a user attempting to access an asset of the system and/or detect a user needing access to an asset of the system. A trigger may be detected by one or more cameras, sensors, software, Internet-of-Things (IoT) devices, or radios of the system. Exemplary triggers 108 may include: an employee is printing a human resources form with a computer (trigger 114); an engineer's lab test failed (trigger 120); software did not execute correctly (trigger 126); an IT worker is entering a building where a server is located (trigger 132); a police officer enters “going to prison” mode on personal device (trigger 140); a police officer vehicle is in a prison parking lot (trigger 146); identify a license plate on a delivery truck outside a door (trigger 150); detect a driver standing out a door (trigger 152).

An action 106 may be an act that is undertaken by the system. By performing the act, the system may provide a user with access to an asset of the system. Exemplary actions 110 may include: unlock a door to a print room (action 116); unlock a door to a lab (action 122); provide read/write access to software (action 128); unlock a door to a server room (action 134); notify a particular security group (action 136); add a police officer to a list of authorized personnel (action 142); notify a prison guard gate (action 144); or unlock the door (action 154).

As an example, a human resources employee may be downloading and printing a human resources form, and the system may understand that that employee started a workflow 112 related to filling and delivering certain documents to a particular place and, as such, should have access to the print room to obtain the printed sheets of paper. The workflow 112 includes the trigger 114 that the employee is printing a form associated with the action 116 to unlock the door to the print room. By assigning the workflow 112 to the employee, the system is providing access to the print room to the employee.

As an example, an engineer may be running a test in a secure lab, and the test may have failed. The system may understand that the engineer started workflow 118 and needs access to the secure lab to review the test. The workflow 118 includes the trigger 120 that the engineer's lab test failed associated with the action 122 to unlock the door to the lab where the test was performed. By assigning the workflow 118 to the engineer, the system is providing access to the lab to the engineer.

As an example, a programmer may be running a software bug fix activity, and after the software bug fix activity concluded, the software still did not execute correctly. The system may understand that the programmer started a workflow 124 and needs access to the software to revise the software. The workflow may include a trigger 126 that the software did not execute correctly associated with an action 128 that provides the programmer read and write permission to the software. By assigning the workflow 124 to the programmer, the system is providing access to the programmer to revise the software.

As an example, an information technology (IT) worker needs to check on a server, and the IT worker enters a building where the server is located. The system recognizes that the IT worker has entered the building and may understand that the IT worker has started a workflow 130 and needs access to the server room where the server is located. The workflow 130 includes a trigger 132 that the IT worker entered the building where the server is located and two actions 134 and 136 associated with the trigger 132. Action 134 unlocks the door to the server room, and action 136 notifies a particular security group that the IT worker has entered the building.

As an example, a police officer may decide to visit a prison and enter a “going to prison” mode on a device of the police officer, and the system may understand that that police officer started a workflow 138 and needs access to the prison. The workflow 138 includes two triggers 140 and 146 and two actions 142 and 144. Trigger 140 occurs when the officer enters the “going to prison” mode on the officer's device and is associated with two actions 142 and 144. Action 142 adds the police officer to the list of authorized personnel for the prison, which may be referenced by the facial recognition software of the prison's video security system to identify authorized personnel and unauthorized personnel on prison grounds. Action 144 notifies the prison guard gate that the police officer will be coming to the prison. Trigger 146 occurs when the police officer's vehicle is in the prison parking lot and is associated with action 144, which notifies the prison guard gate that the police officer's vehicle has arrived. In this example, action 144 occurs when either trigger 140 or trigger 146 occurs.

As an example, a delivery truck may arrive at a building with a delivery, and the system may understand that the delivery truck started a workflow 148 and that the driver needs access to the building. The workflow 148 includes two triggers 150 and 152 and one action 154. Trigger 150 occurs when a video surveillance system identifies the license plate on the delivery truck outside a door of the building. Trigger 152 occurs when the video surveillance system identifies the driver standing outside the door. When triggers 150 and 152 occur, action 152 unlocks the door to allow the delivery to the building. In this example, action 152 occurs once both action 150 and action 152 occur.

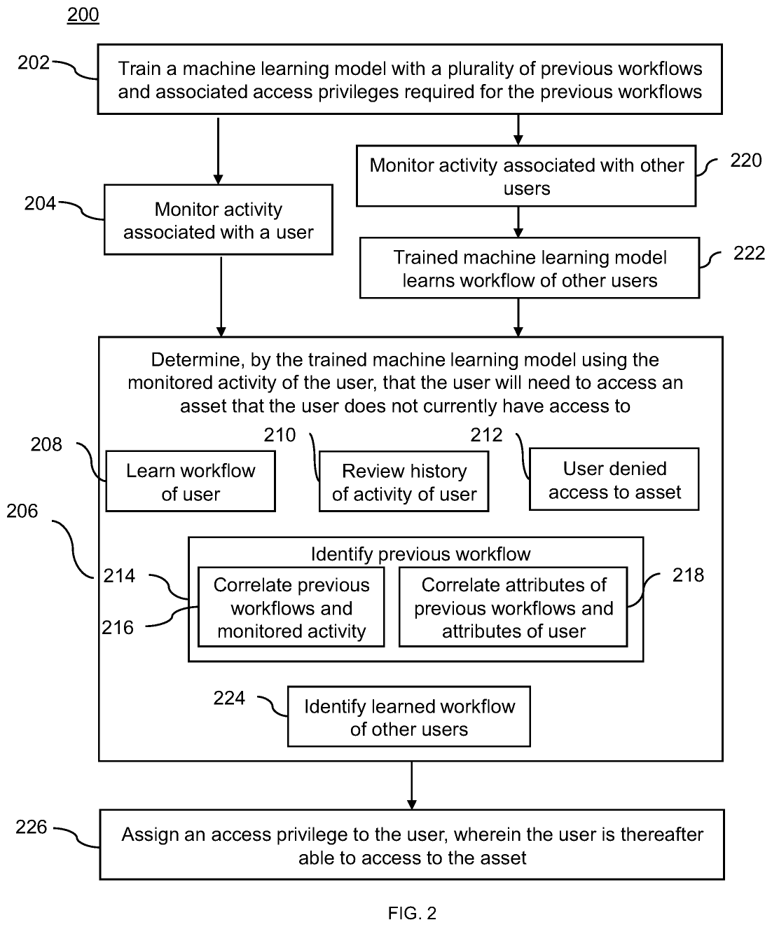

FIG. 2 illustrates an example process 200 for providing dynamic access control using workflow context.

In block 202, a machine learning model may be trained with a plurality of previous workflows and associated access privileges required for the previous workflows. The previous workflows may be completed by previous users and/or programmed by an operator. An access privilege may be an indication that a user is able to access an asset. For example, an access privilege may be one or more of: a list of users authorized to access the asset; an indication in a user profile of the user that the user is able to access the asset; a workflow with access to the asset; or an action associated with a trigger in a workflow. The machine learning model may be trained with workflow context information obtained from the previous workflows. The machine learning model may be trained to learn workflows with associated access privileges.

The machine learning model (e.g., machine learning model 408 in FIG. 4) may be a software program stored in memory (e.g., memory 402 in FIG. 4) and executable by a processor (e.g., processor 404 in FIG. 4). The workflows may be stored in memory (e.g., memory 402) in a database (e.g., workflows database 412 in FIG. 4) and accessible by the machine learning model. The access privileges may be part of the workflows (e.g., an action of a workflow, or metadata of the workflow) stored in memory and/or may be data in user profiles stored in memory (e.g., memory 402) in a database (e.g., user profiles database 414 in FIG. 4), and the access privileges may be accessible by the machine learning model.

The machine learning model may take several different forms (e.g., neural network, linear regression, decision tree, support vector machine, etc.). The machine learning training model may be a combination of hardware and/or software. In some embodiments, the machine learning model may be a neural network, such as a convolutional neural network or a recurrent neural network. Example convolutional neural network algorithms used to train the convolutional neural network may include AlexNet, ResNet, or GoogLeNet, among other possibilities. Example recurrent neural network algorithms to train the recurrent neural network may include a Hopfield bidirectional associative memory network, a long short-term memory network, or a recurrent multilayer perceptron network, among other possibilities.

In some embodiments, the machine learning model may be trained with training data based on workflow context to generate a trained machine learning model. The machine learning model may be trained to learn workflows with corresponding access privileges based on workflow contextual information. The machine learning model may be trained to identify a previous workflow from a plurality of previous workflows.

In some embodiments, the machine learning model may be trained to learn and determine activity patterns or behavior patterns associated with previous workflows completed by previous users and associated access privileges required for those previous workflows. The machine learning model may be executed as a function of monitored user activity to learn an activity pattern associated with a previous workflow.

The training data used to train the machine learning model may be generated as workflow context information associated with previous workflows and associated access privileges required for those previous workflows. Context information for a workflow may be associated with a set of workflow attributes. The set of workflow attributes may include one or more of, for example: triggers; actions; associations between triggers and actions; tasks; assets; access privileges required to access to the assets; user data; user profiles; history of activity associated with users; tasks associated with the access privileges; task status (e.g., completed or uncompleted); workflow status (e.g., denied status or approved status); and any other data associated with workflows and users.

In block 204, the activity associated with a user may be monitored. Monitoring activity associated with the user may include detecting a trigger initiated by at least one of a device associated with the user or an action of the user and/or a detection of the user. For example, the monitored activity may be detecting a device of the user (e.g., a smart phone, a smart watch, or a radio) has communicated with another device. For example, the monitored activity may be detecting the user has performed an action (e.g., entered an area or accessed a computer). For example, the monitored activity may be detecting the user via facial recognition software.

The monitored activity of the user may be stored in a database as a history of activity associated with the user (e.g., database 416 in FIG. 4). For example, the database may store user data indicating that an engineer works on the second shift in a lab associated with an engineering group. The database may store data indicating the date and time when the engineer entered and exited the lab. The database may store data indicating when the engineer performed an experiment in the lab and whether the experiment was a success or a failure.

In block 206, the trained machine learning model may determine, using the monitored activity of the user from block 204, that the user will need to access an asset that the user does not currently have access to. The trained machine learning model may determine that the user will need access to the asset in one or more ways, such as in blocks 208-224, which may be performed using the trained machine learning model separately or in any combination.

In block 208, the trained machine learning model may determine that the user will need access to the asset by learning a workflow of the user based on the monitored activity of the user. The trained machine learning model may be executed as a function of monitored activity of a user to learn a current workflow of the user. For example, an engineer belonging to a particular group may be identified as entering a laboratory, and the trained machine learning model may then determine that the engineer will need access to a locked closet in the laboratory. So, the trained machine learning model may learn a workflow of the engineer where the engineer enters the laboratory (a trigger) and then needs access to the locked closet (an action).

In block 210, the trained machine learning model may determine that the user will need access to the asset by reviewing a history of the activity associated with the user. For example, a history of activity of an engineer indicates that the engineer spent the morning of the last five days in a particular laboratory, and trained machine learning model may determine that the engineer will need access to the laboratory for an additional ten days.

In block 212, the trained machine learning model may determine that the user will need access to the asset based on the user being denied access to the asset. For example, the monitored activity of an engineer may indicate that the engineer tried to access a computer file but was denied access. The trained machine learning model may determine that the engineer will need to access the computer file based on a project that the engineer is assigned to.

Combining blocks 210 and 212, the trained machine learning model may determine that the user will need access to the asset by tracing back through a history of activity associated with the user (block 210) to determine one or more operations the user performed prior to being denied access to the asset (block 212). For example, a history of activity for an engineer may indicate that the engineer attended an internal meeting on a new product development but was subsequently denied access to the computer files for the new product development. The trained machine learning model may determine that the engineer will need access to the computer files based on the engineer attending the internal meeting.

In block 214, the trained machine learning model may determine that the user will need access to the asset by identifying a previous workflow from previous workflows based on the monitored activity of the user. The previous workflows may be those used in training the machine learning model and/or other workflows. The previous workflows may be, for example, workflows of current users, workflows of previous users, workflows learned by the trained machine learning model (e.g., in block 222), workflows programmed by an operator, etc. In some embodiments, the previous workflows may be stored in a database (e.g., workflows database 412 in FIG. 4), and the trained machine learning model may have access to this database. The identified previous workflow may have an access privilege to the asset that the user will need access to. The trained machine learning model may make the determination in block 214 in a variety of ways, such as in blocks 216 and 218, which may be performed using the trained machine learning model separately or in any combination.

In block 216, the previous workflow may be identified by the trained machine learning model by correlating the previous workflows and the monitored activity associated with the user. The trained machine learning model may review the previous workflows to determine at least one previous workflow that best matches with the monitored activity of the user. In some embodiments, the identified previous workflow may have at least one trigger that matches at least one trigger identified from the monitored activity of the user. In some embodiments, the identified previous workflow may have the same or similar monitored activity as the user or include the same task performed by the user. For example, an engineer may be going between two laboratories (e.g., a first trigger of entering a first laboratory, and a second trigger of entering a second laboratory), and the trained machine learning model may identify a previous workflow of going between the two laboratories that also provides access to a third laboratory. As such, the trained machine learning model may determine that the engineer will need access to the third laboratory as well.

In block 218, the previous workflow may be identified by the trained machine learning model by correlating attributes of the plurality of the previous workflows and attributes of the user. The system may assign attributes to workflows and/or users. An attribute may be a descriptor relevant to the organization and/or the system. For example, an attribute may include one or more of a user group, a user job title, a company role, a security level, a job code, an access privilege required to access to an asset; etc. In some embodiments, the system may maintain a database of workflows (e.g., workflows database 412 in FIG. 4), where each workflow may include zero, one, or more attributes, and the trained machine learning model may have access to this database. In some embodiments, the system may maintain a database of user profiles (e.g., user profiles database 414 in FIG. 4), where each user profile may include zero, one, or more attributes of the user, and the trained machine learning model may have access to this database. In some embodiments, the identified previous workflow may have at least one attribute that matches at least one attribute associated with the user. For example, a security officer may have a security level of Level 3 (e.g., a first attribute) and work on Shift 2 (e.g., a second attribute). The trained machine learning model may identify one or more previous workflows for employees with a Level 3 attribute and a Shift 2 attribute, and these identified previous workflows may have access to certain assets in the facility.

In block 220, the activity associated with other users may also be monitored. Similar to monitoring activity of the user discussed above for block 204, the activity associated with other users may also be monitored in similar ways, and a history of activity associated with each user may also be stored in a database.

In block 222, the trained machine learning model may learn a workflow of the other users based on the monitored activity of the other users in block 220. Similar to learning a workflow of the user in block 208, the trained machine learning model may learn a workflow of the other users. The learned workflow of the other users may have an access privilege to an asset. The trained machine learning model may learn one or more workflows of the other users based on the monitored activity of the other users in block 220. The learned workflows of the other users may be stored in a database (e.g., workflows database 412 in FIG. 4).

In block 224, the trained machine learning model may determine that the user will need access to the asset by identifying the learned workflow of the other users from block 222. Similar to identifying a previous workflow in block 214, the trained machine learning model may identify the learned workflow of the other users.

In block 226, an access privilege is assigned to the user, such that the user is thereafter able to access the asset. For example, assigning the access privilege to the user may include one or more of: adding the user to a list of users authorized to access the asset; updating the user profile of the user to indicate that the user is authorized to access the asset; updating a workflow associated with the user with the access privilege (e.g., adding the access privilege as metadata to the workflow, or including the access privilege as an action associated with a trigger in the workflow); assigning to the user a workflow with access to the asset, where the workflow was identified in block 206; or assigning to the user an access privilege from a workflow with access to the asset, where the workflow was identified in block 206. For example, the workflow identified in block 206 may be an identified previous workflow in block 214 and/or a learned workflow of the other users in block 224. The access privilege may be assigned to the user prior to the user needing access to the asset and/or without notifying the user (e.g., the user is not notified that the user is able to access the asset). The access privilege may be assigned to the user for a limited time (e.g., a time window).

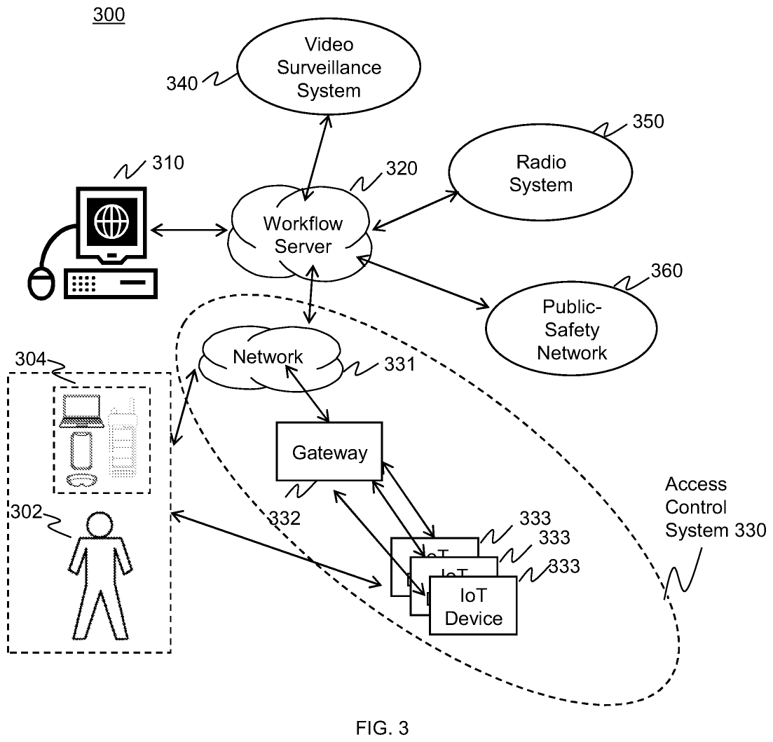

FIG. 3 illustrates an example ecosystem 300 for implementing some embodiments. The ecosystem 300 may be capable of providing dynamic access control using workflow context. The ecosystem 300 may be capable of implementing dynamic access privileges and automating workflows. The ecosystem 300 may be capable of monitoring activity associated with users and detecting triggers identified from the monitored activity across a number of devices within the ecosystem. The ecosystem 300 may be capable of executing actions or providing access privileges associated with workflows to grant users access to corresponding assets to perform tasks associated with workflows. The ecosystem 300 may be a dynamic security ecosystem.

As shown, the ecosystem 300 may include one or more users 302, where each user has zero, one, or more user devices 304, a workstation 310, a workflow server 320, an access control system 330, a video surveillance system 340, a radio system 350, and a public-safety network 360. It should be noted that although the components in FIG. 3 are shown geographically separated, these components can exist within a same geographic area, such as, but not limited to a school, a hospital, a police station, a prison, an airport, a sporting event, a stadium, etc. It should also be noted that although only networks and systems 330, 340, 350, and 360 are shown in FIG. 3, one of ordinary skill in the art will recognize that many more networks and systems may be included in the ecosystem 300.

The user devices 304 associated with the user 302 may be any device configured to interact with the ecosystem 300. For example, the user devices 304 may be configured to send and receive signals from the access control system 330. The user devices 304 may include, for example: a laptop, a tablet, a smart phone, a smart watch, smart glasses, a radio, etc. Although not illustrated in FIG. 3, user 302 and user devices 304 may interact not only with system 330 but also systems 340, 350, and 360.

Workstation 310 may manage, monitor, visualize, configure, revise, and/or update workflows generated, maintained, and/or revised by the workflow server 320. Workstation 310 may be a computer configured to execute Motorola Solutions' Orchestrate™ and Ally™ dispatch and incident management software.

Workflow server 320 may be coupled to the workstation 310 and each system 330, 340, 350, and 360. Workflow server 320 may be configured to monitor activity and events detected by systems 330-360 and may be configured to have systems 330-360 perform certain actions. Workflow server 320 may be configured to: generate, store, and manage user profiles, including any access privileges; monitor activity of users; and generate, store, manage, and execute workflows. Workflow server 320 may perform one or more of the blocks of FIG. 2.

In some embodiments, workflow server 320 may train a machine learning model and then use the trained machine learning model as described herein. Workflow server 320 may learn and determine current workflows and corresponding access privileges using a trained machine learning model based on the monitored activity associated with users. Workflow server 320 may learn that a user will need access to an asset that a user does not currently have access to. Workflow server 320 may dynamically assign a workflow with a learned access privilege to a user. Workflow server 320 may assign a learned access privilege to a user to grant the user access to an associated asset to perform one or more tasks of a workflow. Workflow server 320 may monitor activity associated with a plurality of users and store this monitored activity in a history of activity database (e.g., database 416 in FIG. 4). Workflow server 320 may use the history of activity database and a trained machine learning model to determine one or more new workflows. Triggers of workflows may be capable of being detected by systems 330, 340, 350, and 360, and the detection of the triggers may be capable of being provided to workflow server 320. At the direction of workflow server 320, actions of workflows may be capable of being executed by systems 330, 340, 350, and 360. In some embodiments, workflow server 320 may include a server running Motorola Solutions' Command Central™ software suite comprising the Orchestrate™ platform.

Access control system 330 may be configured to detect various triggers and report the detected triggers to workflow server 320. Access control system 330 may also be configured to receive action commands from workflow server 320 and execute the actions to implement corresponding workflows. Access control system 330 may allow objects to be sensed or controlled remotely across a network. At the direction of workflow server 320, access control system 330 may execute access control to assets in a facility (e.g., to perform an action in a workflow). For example, access control system 330 may unlock and lock a door, turn on and off a device, and/or provide access to a database and/or a computer file. Access control system 330 may interact with user 302 and user devices 304. Access control system 330 may monitor activity of user 302 and provide the monitored activity to workflow server 320. Access control system 330 may monitor activity of user 302 by interaction with user 302 (e.g., user 302 interacting with a computer or a touchpad of access control system 330) and/or by interaction with one or more user devices 304 (e.g., user device 304 communicates with a computer or other device of access control system 330).

Access control system 330 may include a network 331, gateway 332, and Internet of Things (IOT) devices 333. Network 331 may include one of many networks to transmit data. Gateway 332 may be configured to provide communications between IoT devices 333 and workflow server 320. Gateway 332 may include an Avigilon™ Control Center running Avigilon's Access Control Management software. IoT devices 333 may include, for example, a computer, mobile device, car, home appliance, medical device, sensor, door, window, heating, ventilation and air conditioning (HVAC) system, drone, etc.

Video surveillance system 340 may be configured to detect various triggers and report the detected triggers to workflow server 320. Video surveillance system 340 may also be configured to receive action commands from workflow server 320 and execute the actions to implement corresponding workflows. In some embodiments, video surveillance system 340 may include one or more video cameras and an Avigilon™ Control Center (ACC) server having Motorola Solutions' Access Control Management (ACM)™ software suite.

Radio system 350 may be configured to detect various triggers and report the detected triggers to workflow server 320. Radio system 350 may also be configured to receive action commands from workflow server 320 and execute the actions. Radio system 350 may be a private enterprise radio system. In some embodiments, radio system 350 may include a MOTOTRBO™ communication system having radio devices that operate in the Citizens Broadband Radio Service (CBRS) spectrum and combine broadband data with voice communications.

Public-safety network 360 may be configured to detect various triggers and report the detected triggers to workflow server 320. Public-safety network 360 may also be configured to receive action commands from workflow server 320 and execute the corresponding action to implement corresponding workflows. In some embodiments, public-safety network 360 may include typical radio-access network (RAN) elements.

FIG. 4 is a block diagram of a workflow server 320 of FIG. 3. As shown, workflow server 320 may include memory 402, processor 404, and network interface 406.

Memory 402 may include non-transitory computer-readable storage, such as standard memory (e.g., random access memory (RAM), read only memory (ROM), etc.) and may serve to store data (such as, for example, files or databases (e.g., one or more databases 410)) and software instructions (such as, for example, software programs or modules (e.g., a machine learning model 408)). The machine learning model 408 may be executed by processor 404 to implement operations as discussed above for FIG. 2. For example, memory 402 may store Motorola Solutions' Orchestrate™ and Ally™ dispatch and incident management software and/or Motorola Solutions' Command Central™ software suite comprising the Orchestrate™ platform.

As part of the one or more databases 410, memory 402 may store workflows database 412, user profiles database 414, and history of activity database 416. The workflows database 412 may store workflows learned by the ecosystem 300 and/or programmed by an operator. The workflows may be for one or more current users and/or one or more previous users. The user profiles database 414 may store may include profiles for current users and/or previous users. Each user profile may include zero, one, or more attributes of the user. The history of activity database 416 may store histories of monitored activities of users. For example, the history of activity database 416 may store monitored activity and detected triggers associated with users. The history of activity database 416 may include executed actions of allowing users to access assets and perform tasks during corresponding workflows in the ecosystem 300. The history of activity database 416 may include user activity of accessing one or more assets, task information, and task completion status associated with corresponding workflows. The workflows database 412, user profiles database 414, and history of activity database 416 may be implemented as one or more databases.

Processor 404 may include logic circuitry configured to access memory 402 and network interface 406 to implement one or more blocks of FIG. 2. Processor 404 may execute one or more instruction sets and/or software stored in memory 402 and/or access one or more databases 410 stored in memory 402. For example, processor 404 may access databases 410 to train the machine learning model 408 and use the trained machine learning model 408 and the databases 410 according to various embodiments discussed herein.

Network interface 406 may include elements for the processor 404 to interact with other aspects of the ecosystem 300, such as the workstation 310 and the systems 330, 340, 350, and 360.

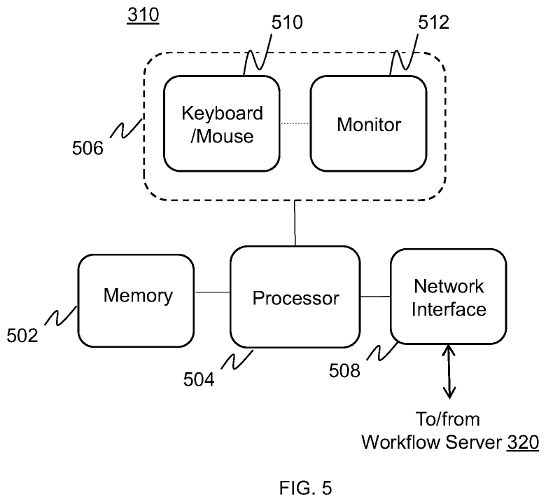

FIG. 5 is a block diagram of a workstation 310 of FIG. 3. Workstation 310 may include memory 502, processor 504, user interface 506, and network interface 508.

Memory 502 may include non-transitory computer-readable storage, such as standard memory (e.g., RAM, ROM, etc.) and may serve to store data (e.g., files or databases) and software instructions (e.g., software programs or modules). In some embodiments, memory 502 may store Motorola Solutions' Orchestrate™ and Ally™ dispatch and incident management software.

Processor 504 may include logic circuitry configured to access memory 502 and network interface 508 to implement one or more blocks of FIG. 2. Processor 504 may execute one or more instruction sets and/or software stored in memory 502 and/or access one or more databases stored in memory 502. For example, the execution of such software may allow an operator to view, monitor, define, and/or revise workflows of the ecosystem 300.

User interface 506 may include one or more user input devices (e.g., keyboard/mouse 510), one or more user output devices (e.g., monitor 512), and/or one or more user input-output devices (e.g., a touchscreen monitor).

Network interface 508 may include elements for the processor 504 to interact with other aspects of the ecosystem 300, such as the workflow server 320.

### Computer-Based Examples

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., cannot electronically monitor activity associated with a user, cannot train a machine learning model, cannot electronically detect a user will need access to an asset, cannot electronically assign an access privilege in an electronic database to a user, among other features and functions set forth herein).

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect of embodiment discussed in this specification.

### Illustrative Examples

The invention includes other illustrative examples, such as the following.

In one illustrative example, a computer-implemented method comprises: monitoring activity associated with a user; determining, using a trained machine learning model and the monitored activity of the user, that the user will need to access an asset that the user does not currently have access to, the trained machine learning model trained with a plurality of previous workflows and associated access privileges required for the previous workflows; and assigning an access privilege to the user, wherein the user is thereafter able to access to the asset.

For the computer-implemented method, determining by the trained machine learning model that the user will need access to the asset comprises learning a workflow of the user based on the monitored activity of the user.

For the computer-implemented method, monitoring activity associated with the user comprises storing in a database a history of activity associated with the user, and wherein determining by the trained machine learning model that the user will need to access the asset comprises reviewing the history of the activity associated with the user.

For the computer-implemented method, determining by the trained machine learning model that the user will need to access the asset is based on the user being denied access to the asset.

For the computer-implemented method, determining by the trained machine learning model that the user will need to access the asset comprises tracing back through a history of activity associated with the user to determine one or more operations the user performed prior to being denied access to the asset.

For the computer-implemented method, determining by the trained machine learning model that the user will need to access the asset comprises identifying a previous workflow from the plurality of previous workflows based on the monitored activity of the user, and wherein the identified previous workflow has an access privilege to the asset, wherein assigning the access privilege to the user comprises assigning the access privilege of the identified previous workflow to the user.

For the computer-implemented method, identifying the previous workflow from the plurality of previous workflows comprises at least one of: correlating the plurality of the previous workflows and the monitored activity associated with the user; or correlating attributes of the plurality of the previous workflows and attributes of the user.

For the computer-implemented method, the identified previous workflow has at least one trigger that matches at least one trigger identified from the monitored activity of the user.

For the computer-implemented method, the identified previous workflow has at least one attribute that matches at least one attribute associated with the user.

For the computer-implemented method, the matched at least one attribute is at least one of a user group, a job title, a company role, a security level, or a job code.

For the computer-implemented method, assigning the access privilege of the identified previous workflow to the user comprises assigning the identified previous workflow to the user.

The computer-implemented method may further comprise: monitoring activity associated with a plurality of other users; and learning, by the trained machine learning model using the monitored activity of the plurality of other users, a workflow of one or more of the plurality of other users based on the monitored activity of the plurality of other users, the learned workflow of the other users having an access privilege to the asset, wherein determining by the trained machine learning model that the user will need access to the asset comprises identifying the learned workflow of the other users, and wherein assigning the access privilege to the user comprises assigning the learned workflow of the other users to the user.

For the computer-implemented method, assigning the access privilege to the user comprises updating a workflow associated with the user with the access privilege.

For the computer-implemented method, the workflow is updated to include the access privilege as an action associated with a trigger in the workflow.

For the computer-implemented method, the access privilege is assigned to the user prior to the user needing access to the asset.

For the computer-implemented method, the user is not notified that the user is able to access the asset.

For the computer-implemented method, the access privilege is assigned to the user for a limited time.

For the computer-implemented method, monitoring activity associated with the user comprises detecting a trigger initiated by at least one of a device associated with the user or an interaction of the user.

For the computer-implemented method, the trigger is at least one of a detection that the device of the user has entered an area, a detection that the device of the user is in communication with another device, a detection that the user has interacted with a processor-based device, or a detection of the user interacting with a facial recognition system.

For the computer-implemented method, the asset is at least one of a physical asset or a logical asset.

For the computer-implemented method, the physical asset is at least one of a door, a gate, a room, or a building, or wherein the logical asset is at least one of an electronic file, a computer-based application, or an electronic resource.

The computer-implemented method may further comprise training a machine learning model to obtain the trained machine learning model, wherein the machine learning model is trained with the plurality of previous workflows and associated access privileges required for the previous workflows, and wherein at least one of the previous workflows was completed by a previous user.

In one illustrative example, a system comprises: a processor; and non-transitory memory coupled to the processor, the memory containing a set of instructions thereon that when executed by the processor cause the processor to: monitor activity associated with a user; determine, using a trained machine learning model and the monitored activity of the user, that the user will need to access an asset that the user does not currently have access to, the trained machine learning model trained with a plurality of previous workflows and associated access privileges required for the previous workflows; and assign an access privilege to the user, wherein the user is thereafter able to access to the asset.

In one illustrative example, a non-transitory processor readable medium contains a set of instructions thereon that when executed by a processor cause the processor to: monitor activity associated with a user; determine, using a trained machine learning model and the monitored activity of the user, that the user will need to access an asset that the user does not currently have access to, the trained machine learning model trained with a plurality of previous workflows and associated access privileges required for the previous workflows; and assign an access privilege to the user, wherein the user is thereafter able to access to the asset.

### CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method comprising:
monitoring activity associated with a user;
determining, using a trained machine learning model and the monitored activity of the user, that the user will need to access an asset that the user does not currently have access to, the trained machine learning model trained with a plurality of previous workflows and associated access privileges required for the previous workflows; and
assigning an access privilege to the user, wherein the user is thereafter able to access to the asset.

2. The computer-implemented method of claim 1, wherein determining by the trained machine learning model that the user will need access to the asset comprises learning a workflow of the user based on the monitored activity of the user.

3. The computer-implemented method of claim 1, wherein monitoring activity associated with the user comprises storing in a database a history of activity associated with the user, and
wherein determining by the trained machine learning model that the user will need to access the asset comprises reviewing the history of the activity associated with the user.

4. The computer-implemented method of claim 1, wherein determining by the trained machine learning model that the user will need to access the asset is based on the user being denied access to the asset.

5. The computer-implemented method of claim 4, wherein determining by the trained machine learning model that the user will need to access the asset comprises tracing back through a history of activity associated with the user to determine one or more operations the user performed prior to being denied access to the asset.

6. The computer-implemented method of claim 1, wherein determining by the trained machine learning model that the user will need to access the asset comprises identifying a previous workflow from the plurality of previous workflows based on the monitored activity of the user, wherein the identified previous workflow has an access privilege to the asset, and
wherein assigning the access privilege to the user comprises assigning the access privilege of the identified previous workflow to the user.

7. The computer-implemented method of claim 6, wherein identifying the previous workflow from the plurality of previous workflows comprises at least one of:
correlating the plurality of the previous workflows and the monitored activity associated with the user; or
correlating attributes of the plurality of the previous workflows and attributes of the user.

8. The computer-implemented method of claim 6, wherein the identified previous workflow has at least one trigger that matches at least one trigger identified from the monitored activity of the user.

9. The computer-implemented method of claim 6, wherein the identified previous workflow has at least one attribute that matches at least one attribute associated with the user.

10. The computer-implemented method of claim 6, wherein assigning the access privilege of the identified previous workflow to the user comprises assigning the identified previous workflow to the user.

11. The computer-implemented method of claim 1, further comprising:
monitoring activity associated with a plurality of other users; and
learning, by the trained machine learning model using the monitored activity of the plurality of other users, a workflow of one or more of the plurality of other users based on the monitored activity of the plurality of other users, the learned workflow of the other users having an access privilege to the asset,
wherein determining by the trained machine learning model that the user will need access to the asset comprises identifying the learned workflow of the other users, and
wherein assigning the access privilege to the user comprises assigning the learned workflow of the other users to the user.

12. The computer-implemented method of claim 1, wherein assigning the access privilege to the user comprises updating a workflow associated with the user with the access privilege.

13. The computer-implemented method of claim 12, wherein the workflow is updated to include the access privilege as an action associated with a trigger in the workflow.

14. The computer-implemented method of claim 1, wherein the access privilege is assigned to the user prior to the user needing access to the asset.

15. The computer-implemented method of claim 1, wherein the access privilege is assigned to the user for a limited time.

16. The computer-implemented method of claim 1, wherein monitoring activity associated with the user comprises detecting a trigger initiated by at least one of a device associated with the user or an action of the user.

17. The computer-implemented method of claim 1, wherein the asset is at least one of a physical asset or a logical asset.

18. The computer-implemented method of claim 1, further comprising training a machine learning model to obtain the trained machine learning model,
wherein the machine learning model is trained with the plurality of previous workflows and associated access privileges required for the previous workflows, and
wherein at least one of the previous workflows was completed by a previous user.

19. A system comprising:
a processor; and
non-transitory memory coupled to the processor, the memory containing a set of instructions thereon that when executed by the processor cause the processor to:
monitor activity associated with a user;
determine, using a trained machine learning model and the monitored activity of the user, that the user will need to access an asset that the user does not currently have access to, the trained machine learning model trained with a plurality of previous workflows and associated access privileges required for the previous workflows; and
assign an access privilege to the user, wherein the user is thereafter able to access to the asset.

20. A non-transitory processor readable medium containing a set of instructions thereon that when executed by a processor cause the processor to:
monitor activity associated with a user;
determine, using a trained machine learning model and the monitored activity of the user, that the user will need to access an asset that the user does not currently have access to, the trained machine learning model trained with a plurality of previous workflows and associated access privileges required for the previous workflows; and
assign an access privilege to the user, wherein the user is thereafter able to access to the asset.
